(19) United States
(12) Patent Application Publication
(10) Pub. No.: US 2019/0236300 A1
(43) Pub. Date: Aug. 1, 2019

(54) SERVICE PROCESSING METHOD AND APPARATUS, DATA SHARING SYSTEM, AND STORAGE MEDIUM

(71) Applicant: TENCENT TECHNOLOGY (SHENZHEN) COMPANY LIMITED, Shenzhen (CN)

(72) Inventors: Rui GUO, Shenzhen (CN); Maocai Li, Shenzhen (CN); Qi Zhao, Shenzhen (CN); Jianjun Zhang, Shenzhen (CN); Haitao Tu, Shenzhen (CN); Zongyou Wang, Shenzhen (CN); Jun Liang, Shenzhen (CN); Dawei Zhu, Shenzhen (CN); Lisheng Chen, Shenzhen (CN); Binhua Liu, Shenzhen (CN)

(73) Assignee: TENCENT TECHNOLOGY (SHENZHEN) COMPANY LIMITED, Shenzhen (CN)

(21) Appl. No.: 16/382,663

(22) Filed: Apr. 12, 2019

Related U.S. Application Data
(63) Continuation of application No. PCT/CN2018/079075, filed on Mar. 15, 2018.

(30) Foreign Application Priority Data
Mar. 30, 2017 (CN) 201710203678.3

(51) Int. Cl. G06F 21/62; G06F 16/182; H04L 9/32; H04L 9/08; H04L 9/06; H04L 9/30

(52) U.S. Cl. CPC G06F 21/6218; G06F 16/1824; H04L 9/30; H04L 9/0825; H04L 9/0643; H04L 9/3247

(57) ABSTRACT

A method, system and computer readable medium are provided. The method includes receiving a service processing request from a user client, the service processing request being generated according to a table structure provided by a data sharing system, and including service data and signature information of the service data. The service data and the signature information are extracted from the service processing request according to the table structure that is prestored. A service data recording request of the data sharing system is generated, the service data recording request including the service data and the signature information. The service data recording request is sent to one or more nodes in the data sharing system for obtaining and storing the service data and the signature information at the one or more nodes.

### CROSS-REFERENCE TO RELATED APPLICATIONS

This application is a continuation of International Application No. PCT/CN2018/079075, filed on Mar. 15, 2018, which claims priority from Chinese Patent Application No. 201710203678.3, filed with the Chinese Patent Office on Mar. 30, 2017, and entitled “SERVICE PROCESSING METHOD AND APPARATUS, AND DATA SHARING SYSTEM”, the entire contents of each of which are incorporated by reference herein in their entireties.

### FIELD OF THE TECHNOLOGY

The present disclosure relates to the field of network technologies, and in particular, to a service processing method and apparatus, and a data sharing system.

### BACKGROUND OF THE DISCLOSURE

With constant development of information technologies, blockchain, as a brand new technology, has been rapidly developed. The blockchain technology is derived from the Bitcoin technology that appeared in 2008, and is an underlying technology of Bitcoin. Blockchain refers to a string of associated blocks that are generated by using a cryptography method. Block data of each block in the blockchain is associated with block data in a previous block. Therefore, no cheating may be performed by tampering with the block data. It may be ensured that the block data of any block is transparent, thereby improving security of input information.

### SUMMARY

It is an aspect to provide a service processing method and apparatus, and a data sharing system.

According to an aspect of one or more embodiments, there is provided a method comprising receiving, by at least one processor, a service processing request from a user client, the service processing request being generated according to a table structure provided by a data sharing system, and including service data and signature information of the service data; extracting, by at least one processor, the service data and the signature information from the service processing request according to the table structure that is prestored; generating, by at least one processor, a service data recording request of the data sharing system, the service data recording request including the service data and the signature information; and sending, by at least one processor, the service data recording request to at least one node in the data sharing system for obtaining and storing the service data and the signature information at the at least one node.

According to additional aspects of one or more embodiments, there are also provided a system and a non-transitory computer readable storage medium consistent with the method.

### BRIEF DESCRIPTION OF THE DRAWINGS

Various embodiments are described below with reference to the drawings, in which:

FIG. 1 is a schematic structural diagram of a data sharing system according to an embodiment;

FIG. 2 is a flowchart of a service processing method according to an embodiment;

FIG. 3 is a diagram of interface display of a user client according to an embodiment;

FIG. 4 is a diagram of an adaption relationship between a user client and a data sharing system according to an embodiment;

FIG. 5 is a schematic diagram of block data content according to an embodiment;

FIG. 6 is a flowchart of a service processing method according to an embodiment;

FIG. 7 is a diagram of data exchange between an enterprise client and a data sharing system according to an embodiment;

FIG. 8 is a schematic diagram of an address information generation manner according to an embodiment;

FIG. 9 is a diagram of a generation principle according to an embodiment;

FIG. 10 is a schematic layered diagram of a data sharing system according to an embodiment;

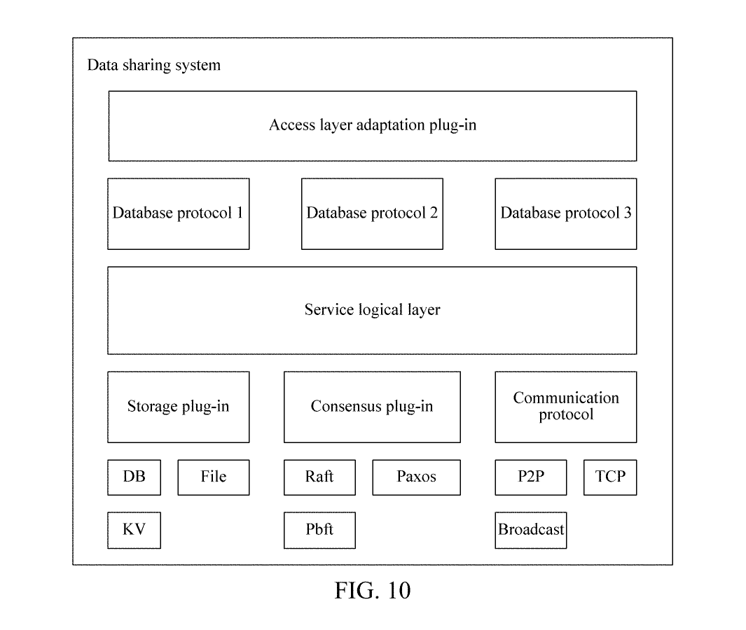

FIG. 11 is a schematic functional diagram of a data sharing system according to an embodiment;

FIG. 12 is a schematic structural diagram of a service processing apparatus according to an embodiment;

FIG. 13 is a schematic structural diagram of a service processing apparatus according to an embodiment;

FIG. 14 is a schematic structural diagram of a service processing apparatus according to an embodiment;

FIG. 15 is a structural block diagram of a terminal 1500 according to an embodiment; and

FIG. 16 is a block diagram of a service processing apparatus 1600 according to an embodiment.

### DETAILED DESCRIPTION

To make the objectives, technical solutions, and advantages of the present disclosure clearer, the following further describes implementations of various embodiments in detail with reference to the accompanying drawings.

According to various embodiments described herein, a table structure supported by a data sharing system is provided for a client, so that the client may trigger, in a database, a service processing request in a form of a data statement based on the table structure. Therefore, when receiving such a service processing request in the form of a data statement, a data sharing system side may identify and process the service processing request, thereby greatly reducing a technical threshold of the data sharing system; and a plurality of existing database service systems may be seamlessly connected to the data sharing system, thereby improving the universality of blockchain technologies.

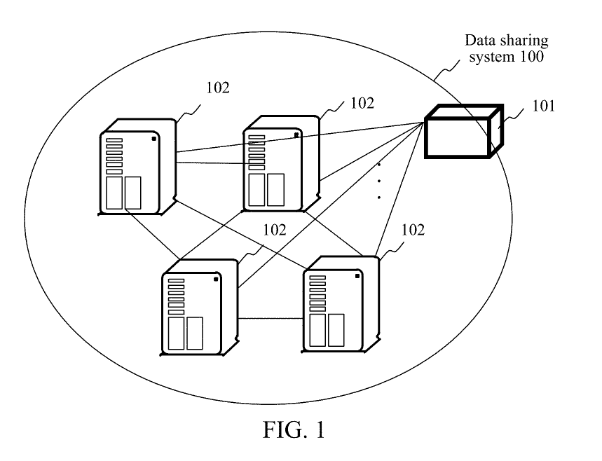

Referring to a data sharing system shown in FIG. 1, the data sharing system 100 is a system for data sharing between nodes. The data sharing system 100 may provide a data service for a user client. The data sharing system 100 includes a data sharing system gateway 101 and a plurality of nodes 102. The nodes may be, for example, terminal devices. The data sharing system 100 may include the data sharing system gateway 101 and the plurality of nodes 102. The data sharing system gateway 101 is configured to perform request conversion and verify address information, and so on. The plurality of nodes 102 may refer to servers and the like provided by various enterprises and financial institutions in the data sharing system. The data sharing system gateway 101 is configured to: receive a service processing request, the service processing request being generated according to a table structure provided by the data sharing system, and the service processing request including service data of a user and signature information of the service data of the user; extract the service data and the signature information of the user from the service processing request; generate a service data recording request of the data sharing system, the service data recording request including the service data and the signature information of the user; and send the service data recording request to at least one node 102 in the data sharing system. Any node 102 of the plurality of nodes is configured to provide a data service based on the received service data recording request. The data service may be, for example, a service such as performing writing into a shared account book or account information query.

Each node 102 may receive input information (for example, the service data) of the user client during normal work, and maintain shared data in the data sharing system based on the received input information. To ensure information interworking in the data sharing system, any communication protocol may be used between nodes in the data sharing system, so that information may be transmitted between the nodes. The communication protocol may include peer to peer (P2P), a transmission control protocol (TCP), a user datagram protocol (User Datagram Protocol, UDP), and a multicast form. When any node in the data sharing system receives input information, other nodes in the data sharing system obtain the input information according to a consensus algorithm, and store the input information as shared data, so that data stored on all nodes in the data sharing system is consistent. The data sharing system may be a transaction system, the transaction system is a system for financial transaction. The transaction system may include a plurality of nodes. Each node generates account book data during a transaction, and maintains a shared account book in the transaction system based on the account book data.

1. It is very difficult for a blockchain technology to be seamlessly connected to a conventional service due to its unique system architecture and data processing manner. A conventional database service has a relatively high requirement on a technical threshold and relatively weak applicability, and therefore, is not beneficial to promotion and application of the blockchain technology.

2. An existing data sharing system usually uses a key having relatively low strength. For example, a Bitcoin system simply uses 256-bit random numbers, and simply uses an SHA256 digest algorithm, which will be possibly decrypted in the future.

3. An intelligent contract cannot have both security and flexibility. An existing intelligent contract technology has many security problems. Turing provided by a Bitcoin mechanism is not complete, and languages thereof cannot be flexibly used in a plurality of service scenarios.

For the foregoing defects, various embodiments provide corresponding solutions. The following describes the corresponding solutions from different perspectives.

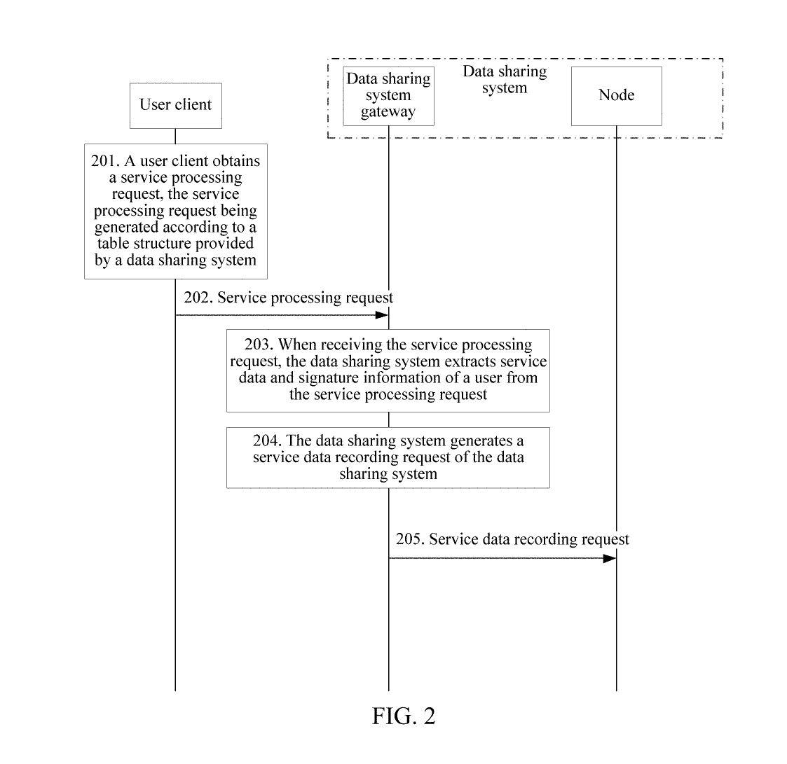

An embodiment provides a service processing method, to reduce a technical threshold of a data sharing system. A plurality of existing database service systems may be seamlessly connected to the data sharing system, thereby improving universality of blockchain technologies. Referring to FIG. 2, an example in which a user client and a data sharing system are exchange bodies is used to describe the service processing method.

In step 201, a user client obtains a service processing request, the service processing request being generated according to a table structure provided by a data sharing system, and the service processing request including service data of a user and signature information of the service data of the user.

The user client is a client of a user that has registered with the data sharing system in advance. The user may process a service with the data sharing system by using the user client. When displaying a service processing interface to the user, the user client may display, in the service processing interface, the table structure provided by the data sharing system, so that the user client may obtain the service processing request based on the table structure. The table structure includes information such as a name and a field of a table for storing data in a database, and a field serving as a primary key. The foregoing information is used for service processing such as data query and data insertion.

It should be noted that a process of constructing the service processing request may be: The user directly enters a data statement of the service processing request according to the table structure, and the user client adds the signature information to the statement; or the user client generates a statement based on the service data and the like entered by the user, and adds the signature information of the service data to the statement. A specific process thereof may include: obtaining, by the user client, the service data of the user; obtaining, by the user client, a private key of the user, and signing the service data by using the private key, to obtain signature information of the user; and encapsulating the service data and the signature information of the user into the service processing request. The service data entered by the user is subsequently stored in an information field of a block generated by the data sharing system. The service data may refer to transaction information of the user. For example, the service data may include: address information of a transferor, address information of a transferee, and a transaction amount.

It should also be noted that when the user client signs, the user client may select, based on service types corresponding to different service processing requests, different lengths of data in the service data for signing. For example, data statements of some service processing requests have relatively long lengths, and a segment of service data having a relatively short length may be obtained for signing; and data statements of some service processing requests have relatively short lengths, and a segment of service data having a relatively long length may be obtained for signing. In this way, signatures for different service levels are obtained. A service level signature is automatically performed on an ordinary SQL statement.

For example, an example in which a database system used by the user client is MySQL, and the data sharing system is named TrustSQL is used. A TrustSQL gateway (that is, an access layer (API)) is adapted to MySQL, a developing personnel may access TrustSQL by using a built-in drive of MySQL to join in the data sharing system. For the developing personnel, the operation is the same as a regular operation on MySQL. A bottom-layer protocol of TrustSQL is invisible to the user client. TrustSQL provides a fixed table structure for the user client, where the table structure may support operations such as inserting and selecting an account in an info field of a block of the data sharing system.

An SQL statement obtained by the user client may be:

Insert into t_transaction set //a function of this statement is to add transaction information to a shared account book

from_address=‘1H3ktZnx6XtxkC4Ck31r4GzjpjWaLHvGVj’, //address information of a transferor

to_address=“1MZLjFBPgXTgWSxZJEhFkgwaTf93cStDCA”, //address information of a transferee

amount=100, //a transaction amount is 100

sign=‘MEQCIHOksbcX9kT0gJOJkIe2HlODcgHetqAlcfx7dMZXapDjAiB9T6e1Q8 McMQAvYYbNdWuQrvaOl6/oO7YEgqR5jGBy5g’, //a signature of transaction information

publickey=‘BHSgdFFuE8p0FQ5+Ge1AO5XAj8su5B8UpAtWo9zNXifUk9+6T4L5r VxhxRWU7t83zek7EYTYap6EY1LWl2Qc/Ro’; //a public key of transaction information

where sign is calculated according to an elliptic curve digital signature algorithm

sign=ECDSA(private_key,(from_address+to_address+amount)),

where private_key is a private key owned by the user, and “from_address+to_address+amount” is the transaction information; because the private key is generated and saved by the user client, the signature information may prevent the service data of the user from being tampered with; and for a specific generation process of the private key, refer to a detailed description of the following key management part.

If a hacker logs in to a database to tamper with data in the database, the data sharing system may compare signature information included in a query request with signature information stored in a block. Once it is determined through the query that the two pieces of signature information are inconsistent, the inconsistent information indicates that the data has been tampered with, and the part of service data that has been tampered with may be determined by using block eigenvalues, thereby returning an error code to a user to indicate that the data has been tampered with.

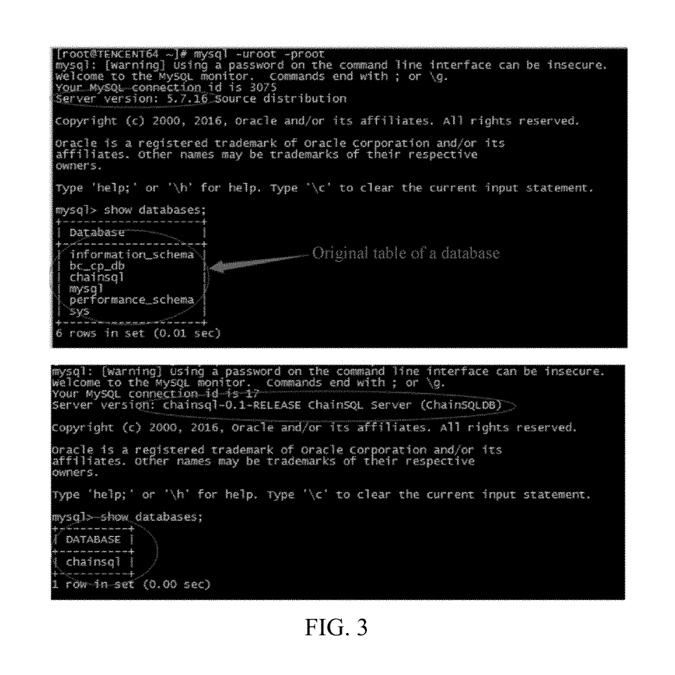

It should be noted that after the user client is adapted to the data sharing system, other service tables may be shielded, and only a blockchain table in the data sharing system is exposed. For example, an example in which a database system used by the user client is MySQL is used. After the user client is logged in to, a display interface of MySQL thereof may change from an original table (the upper image shown in FIG. 3) to a blockchain table (the lower image shown in FIG. 3).

In step 202, the user client sends the service processing request to the data sharing system.

The user client may send the service request to the data sharing system through a connection to the data sharing system. The sending may be implemented based on previous system adaption, so that the user client may send the service processing request to the data sharing system by using a database drive of the client.

In step 203, when receiving the service processing request, a service processing apparatus of the data sharing system extracts the service data and the signature information of the user from the service processing request according to the table structure that is prestored.

In this embodiment, the data sharing system may have a data sharing system gateway, configured to isolate an external network from an intra-system node, so that the intra-system node is not transparent for a user of the external network, and is not sensed by the user of the external network. A specific used data protocol does not need to be learned by the user of the external network. The data sharing system gateway may be configured to: receive the service processing request, and convert the service processing request into a service data recording request.

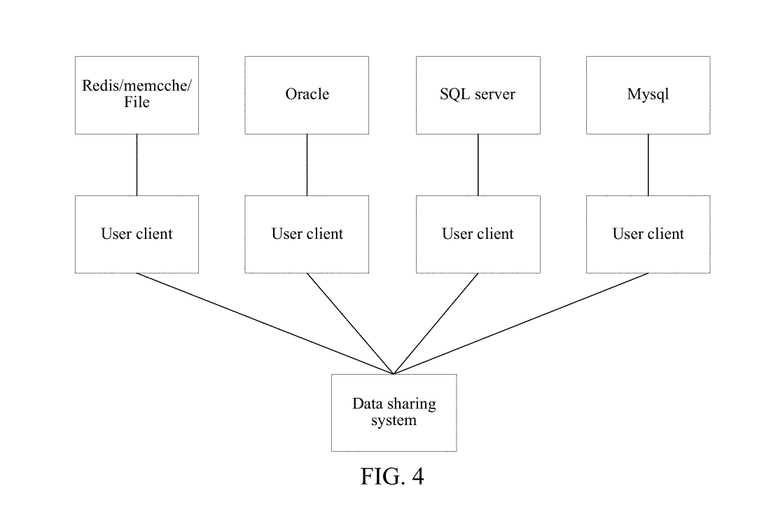

Because adaptation between the user client and the data sharing system has been performed in advance, the data sharing system gateway may extract key data in the service processing request after receiving the service processing request. Certainly, because the data sharing system may support a plurality of different database types, step 203 may further include the following process: identifying a database type for generating the service processing request, for example, a database type included in the service processing request; determining, from a correspondence between a database type and a table structure according to the database type, the table structure used to generate the service processing request; and extracting the service data and the signature information of the user from a corresponding field of the service processing request based on the table structure used to generate the service processing request. Because different database types may correspond to different data statements, different table structures may be provided to generate a service processing request. Therefore, a database type for generating a service processing request needs to be identified first in an extraction process, for accurate extraction. Certainly, a same table structure may be provided for different database types. However, meanings of the table structure in different database types still need to be known. That is, a database type for generating a service processing request is learned, to implement effective identification. As shown in FIG. 4, database types supported by the data sharing system include: Oracle, MySQL, SQL server, Redis, memcche, and File. This is not specifically limited in this embodiment;

In the data sharing system, once a user system supporting a database type is added, a database protocol may be directly adapted in the data sharing system. That is, a table structure and an extraction manner for the database type are set on the data sharing system gateway, and an existing data protocol and the like inside the data sharing system do not need to be modified. For a user system side, because no isolation needs to be performed on the user system side and inside the data sharing system, the user system side may generate, only by learning of the table structure provided by the data sharing system, a service processing request based on the table structure by using an existing database drive of the user system side, to insert into a shared account book, select an account for an operation, and so on in the data sharing system.

Using the foregoing SQL statement as an example, it may be extracted that

Insert into t_transaction set

from_address=‘1H3ktZnx6XtxkC4Ck31r4GzjpjWaLHvGVj’,

to_address=“1MZLjFBPgXTgWSxZJEhFkgwaTf93cStDCA”,

amount=100, //the foregoing is service data

sign=‘MEQCIHOksbcX9kT0gJOJkIe2HlODcgHetqAlcfx7dMZXapDjAiB9T6e1Q8 McMQAvYYbNdWuQrvaOl6/oO7YEgqR5jGBy5g’, //signature information

publickey=‘BHSgdFFuE8p0FQ5+Ge1AO5XAj8su5B8UpAtWo9zNXifUk9+6T4L5r VxhxRWU7t83zek7EYTYap6EY1LWl2Qc/Ro’; //a public key

Further, when receiving the service processing request, the data sharing system may generate address verification information of the user client according to a public key of the user client included in the service processing request; and if the address verification information of the user client is consistent with address information included in the service data, step 203 and a subsequent step are performed in response to the service processing request; or if the address verification information of the user client is inconsistent with address information included in the service data, the service processing request is intercepted, and a subsequent step is not performed, and further, the user client may be warned that the current service processing request has been tampered with. A specific process for generating the address verification information of the user client is described in detail in the subsequent key management part, and details are not described herein.

In step 204, the data sharing system generates the service data recording request of the data sharing system, where the service data recording request carries the service data and the signature information of the user.

The data sharing system regenerates a service data recording request based on the extracted service data and signature information of the user and according to a request format supported by the data sharing system, to process data inside the data sharing system. This process may be regarded as format transformation on the service processing request, so that a data statement may be identified and processed by the data sharing system. Applicability of the data sharing system is greatly improved through such format transformation, thereby reducing a technical threshold.

In step 205, the data sharing system sends the service data recording request to at least one node in the data sharing system, so that the at least one node obtains the service data and the signature information from the service data recording request, and stores the service data and the signature information.

Global sending may be performed on the service data recording request in the data sharing system. That is, the data sharing system gateway broadcasts the service data recording request to each node in the data sharing system, or the data sharing system gateway may broadcast a blockchain access request to a key node or a transaction node, instead of all nodes, in the data sharing system, and then, the key node or the transaction node further performs broadcasting. Specific nodes to which the blockchain access request is sent are not limited in this embodiment.

In an embodiment of this application, when receiving the service data recording request, a node generates an eigenvalue of a current block according to the service data and the signature information of the user.

When receiving the service data recording request, a node may obtain a block eigenvalue of a parent block. The parent block is a previous block associated with the current block. Block data of each block in a blockchain includes input information (that is, the service data), the signature information, a block header eigenvalue of the parent block, an input information eigenvalue, a version number, a timestamp, a difficulty value, and the like. When a block is generated, eigenvalue calculation needs to be performed according to the foregoing information, to calculate a block eigenvalue of the current block.

To increase the encryption difficulty, when the eigenvalue of the current block is generated, parallel calculation is performed by using a plurality of hash algorithms, for example, information, such as the service data and the signature information of the user, used to generate an eigenvalue may be divided into at least two parts of data; different hash algorithms are respectively used for the at least two parts of data for calculation, to obtain hash values of the at least two parts of data; and the hash values of the at least two parts of data are concatenated, to obtain the eigenvalue of the current block. For example, the different hash algorithms may include an SHA256 algorithm, an SM3 algorithm, and the like.

The dividing the service data and the signature information of the user into at least two parts of data includes: determining a division quantity according to data amounts of the service data and the signature information of the user; and dividing the service data and the signature information of the user into the determined division quantity of data. Information used to generate an eigenvalue may be evenly divided into two parts. For example, 256-bit data is divided into two parts, the first 128 bits use the SHA256 algorithm, and the latter 128 bits use the SM3 algorithm. Certainly, three different algorithms may be used. That is, information used to generate an eigenvalue is divided into three parts, and different parts use different algorithms, or neighboring parts use different algorithms. This is not limited in this embodiment. An eigenvalue obtained after a parallel algorithm is irreversible, thereby greatly improving security. Moreover, an algorithm used to generate an eigenvalue may be changed anytime according to an algorithm setting of the data sharing system, so that when the algorithm is decrypted, remediation may be made in time.

In an embodiment of this application, the node generates the current block based on the service data and the signature information of the user, the eigenvalue of the previous block, and the eigenvalue of the current block in the blockchain.

It should be noted that, that the foregoing verification succeeds may mean that a plurality of nodes in the data sharing system determines, by using the consensus algorithm, that the current service data may be added to the blockchain.

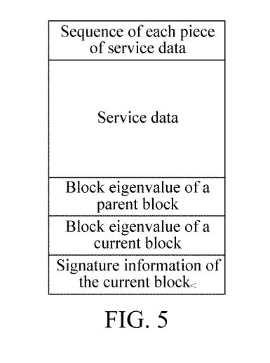

Further, based on this step, a node may sign to-be-stored information in a block again based on a private key of the node, to construct a second layer of anti-tampering mechanism based on the first layer of anti-tampering of the service data and the signature information, thereby greatly improving the security. That is, this step may include: signing, by the node, the service data and the signature information of the user, the eigenvalue of the previous block, and the eigenvalue of the current block in the blockchain by using the private key of the node, to obtain signature information of the current block; and correspondingly storing the service data and the signature information of the user, the eigenvalue of the previous block and the eigenvalue of the current block in the blockchain, and the signature information of the current block, and generating the current block. Referring to FIG. 5, Node_sign in FIG. 5 refers to the signature information of the current block. Because Node_sign has recorded an abstract of current data signed by the node by using the private key of the node, it may be avoided that local data is tampered with after the node is attacked. An index attribute in FIG. 5 indicates a sequence of each piece of service data, which sequentially ascends from 1. If a problematic node (that is, a node with incorrect data in a block) appears, the node may be recovered by obtaining correct data of another node according to an index number. A newly added node may also obtain the latest snapshot data and a recording of an increment according to a snapshot taken on an index, to catch up with data of an existing node as fast as possible. pre-hash refers to a block eigenvalue of a parent block, and hash refers to the block eigenvalue of the current block. info represents the service data of the user.

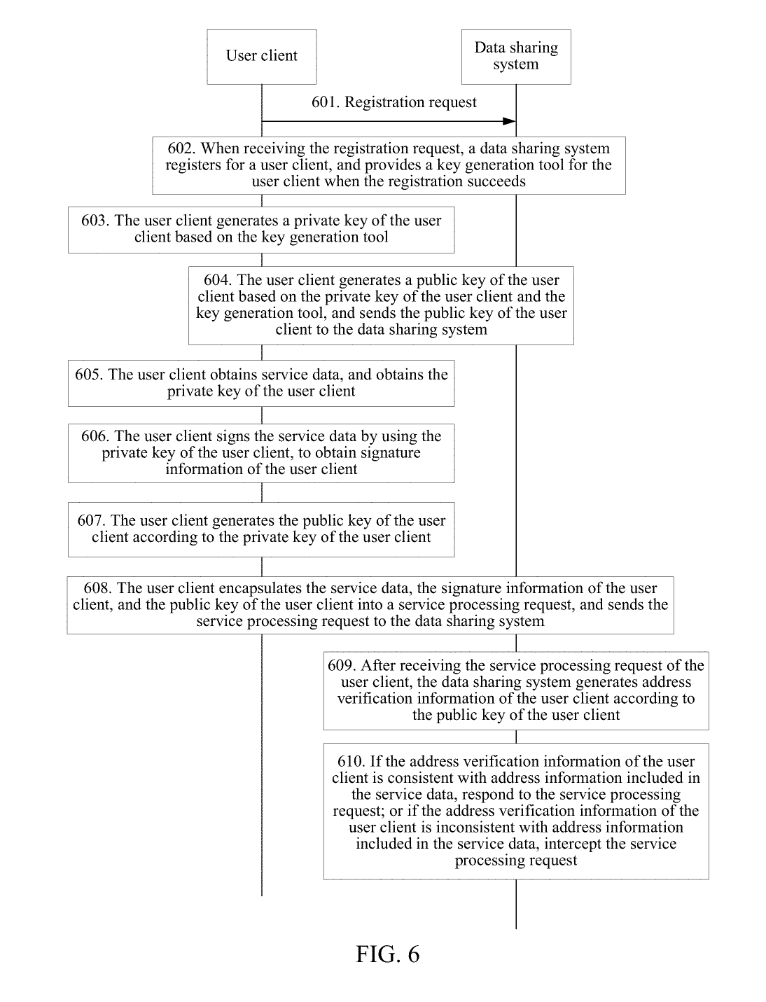

To resolve the problem that key strength of an existing data sharing system is relatively low, an embodiment provides a management service, which includes a key management method. An extensible quantity of bits of a key and/or a plurality of extensible high-strength hash algorithms are used together, to avoid a decryption risk caused due to a single algorithm. The key management method may be for a user of the data sharing system. The user is a user processing a service by using the data sharing system, and may be an individual user or an enterprise user. For ease of description, a client used by such a user is referred to as a user client below. To use a service provided by the data sharing system, the user client needs to register with the data sharing system. Referring to FIG. 6, the following steps 601 to 610 are the registration process and a service processing process after the registration succeeds.

In step 601, a user client sends a registration request to a data sharing system.

The registration request may be used to register with the data sharing system, to process a service. A user client serving as an individual user may perform registration by providing basic information such as personal identity information.

In step 602, when receiving the registration request, the data sharing system registers for the user client, and provides a key generation tool for the user client when the registration succeeds.

The key generation tool is used to indicate an algorithm used by the user client to generate a key, for example, an algorithm used to generate a private key, an algorithm used to generate a public key, or an algorithm used to generate address information.

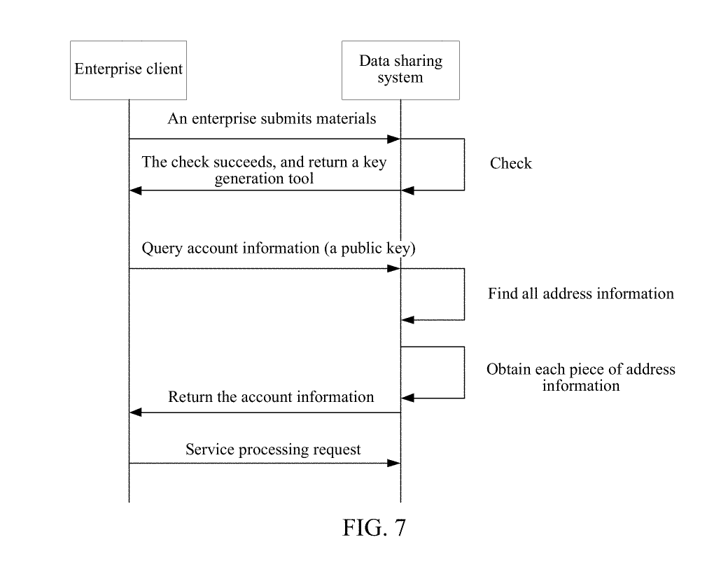

In addition, a registration request of a common user may only include information used in registration, for example, personal identity information. An enterprise user further needs to submit corresponding materials such as enterprise identity information when submitting a registration request, so that the data sharing system checks the information, and may register for the enterprise user only after the check succeeds. For example, using FIG. 7 as an example, an enterprise submits materials for registration. A key generation tool is returned to an enterprise client after check on the materials succeeds. After the enterprise client generates a public key and address information based on the key generation tool, a key management service of the data sharing system may record the public key and the address information of the enterprise, and information corresponding to an enterprise identity. The public key may be publicized. Each service processing request may include signature information and a public key of an enterprise client, to identify an identity of a person. In addition, the enterprise client may query account information based on the public key. The data sharing system queries, according to the public key, the address information corresponding to the enterprise client, and obtains each piece of address information to return account information. The account information actually is information such as an account balance corresponding to the address information of the enterprise client. Certainly, another service processing request may be performed based on the public key. This is not specifically limited in this embodiment.

In step 603, the user client generates a private key of the user client based on the key generation tool.

The private key of the user client is generated by the user client based on the key generation tool of the data sharing system. For example, a random number having a first specified quantity of bits is generated by using an asymmetric encryption algorithm; a quantity of bits of the random number having the first specified quantity of bits is extended, to obtain a random number having a second specified quantity of bits, and the random number having the second specified quantity of bits is used as the private key of the user client. The extension on the quantity of bits may be integer-multiple extension. For example, a 256-bit random number is extended into a 512-bit random number. Specifically, the extension on a quantity of bits may be performed based on a character of the obtained random number. For example, two random numbers having the first specified quantity of bits are concatenated, to obtain the random number having the second specified quantity of bits. Three concatenation manners are mainly described herein:

(1) A tail of one random number having the first specified quantity of bits is connected to a head of the other random number having the first specified quantity of bits, to obtain the random number having the second specified quantity of bits.

In such tail-head concatenation, a same random number is repeatedly used twice. Such a concatenation manner is relatively simple, and has a small calculation amount, thereby avoiding overly occupying a calculation resource. For example, a random number abc may be extended into abcabc.

(2) A character having a preset quantity of bits in one random number having the first specified quantity of bits is mixed, in an insertion manner, with a character having the preset quantity of bits in the other random number having the first specified quantity of bits, to obtain the random number having the second specified quantity of bits.

Such insertion mixing is actually to stagger random numbers. Such a concatenation manner is relatively simple, and has a small calculation amount. One of random numbers is staggered backward and is combined with another random number. For example, for a random number abcde, one abcde may be staggered backward by two bits, as shown in the following manner:

abcde

abcde

where insertion mixing is performed on the foregoing staggered random numbers, to obtain abcadbecde.

(3) One random number having the first specified quantity of bits and the other random number having the first specified quantity of bits are disrupted, to obtain the random number having the second specified quantity of bits. Because such a random disruption manner is randomly performed, irreversibility thereof is most stable, so that a public key generated based on such a private key has higher security.

For a private key obtained through the foregoing extension on a quantity of bits, an example in which an initial random number generated by using an algorithm has 256 bits is used. If a designed extensible key length supports 512 bits at most, according to a current calculation speed of a quantum computer, assuming that a super computer violently tries one billion passwords per second, 24.3 billion years are needed to decrypt 15 bits. The decryption difficulty is enough for ensuring security of a key. Certainly, in addition to the concatenation manners described above, there may be other concatenation manners, and details are not described herein. It should be noted that any concatenation manner that may mix numbers up is applicable to the present disclosure.

In step 604, the user client generates a public key of the user client based on the private key of the user client and the key generation tool, and sends the public key of the user client to the data sharing system.

The generating a public key of the user client includes: generating the public key of the user client according to the private key of the user client and an algorithm that is used to generate the public key and that is indicated by the key generation tool. For example, if the algorithm that is used to generate the public key and that is indicated by the key generation tool is a hash operation, the private key may be calculated according to a specific algorithm of the hash operation, to obtain the public key. For example, if the specific algorithm of the hash operation is SECO256K1 (an elliptic curve cryptography), the public key of the user client is obtained based on the algorithm.

In the data sharing system, a public key of a user client may be used to represent a displacement identity of the user client. Therefore, the public key may further be sent to the data sharing system, so that the data sharing system generates a public key list based on public keys of a plurality of user clients, and broadcasts the public key list to each node. In this way, each node may verify a service processing request when processing a service. When any service processing request is received, whether the public key list includes a public key included in the service processing request is queried first. If yes, next step of processing may be performed on the service processing request, for example, verification on the signature information.

In step 605, the user client obtains service data, and obtains the private key of the user client.

The process of obtaining the service data and the private key is the same as the process described in step 201, and details are not described herein again.

In step 606, the user client signs the service data by using the private key of the user client, to obtain signature information of the user client.

A specific process of obtaining the signature information is also the same as the process of generating the signature information in step 201, and details are not described herein again.

In step 607, the user client generates the public key of the user client according to the private key of the user client.

Step 607 is a process of generating the public key in real time. During actual implementation, the public key may alternatively be generated and stored in the user client in advance, so that the public key is extracted from a memory and is used when there is a service requirement, and does not need to be generated in real time, to reduce calculation resources during actual operation.

In step 608, the user client encapsulates the service data, the signature information of the user client, and the public key of the user client into a service processing request, and sends the service processing request to the data sharing system.

A process of step 608 is the same as a process of generating the service processing request in the step 201, and details are not described herein again.

In step 609, after receiving the service processing request of the user client, the data sharing system generates address verification information of the user client according to the public key of the user client, the service processing request including the service data and the public key of the user client, and the service data including address information of the user client.

A specific process of generating address verification information of the user client according to the public key of the user client may include: obtaining a public key hash value of the user client; performing at least two hash operations on the public key hash value, to obtain a hash value of the public key hash value; extracting, from the hash value of the public key hash value, a byte having a first preset quantity of bits, to serve as a verification code; and concatenating the public key hash value and the verification code, and coding, by using a data format supported by the data sharing system, a character string obtained after the concatenation, to obtain the address information of the user client. Further, during concatenation, version information used to represent a system version may be added, that is, the version information of the data sharing system, the public key hash value, and the verification code are concatenated.

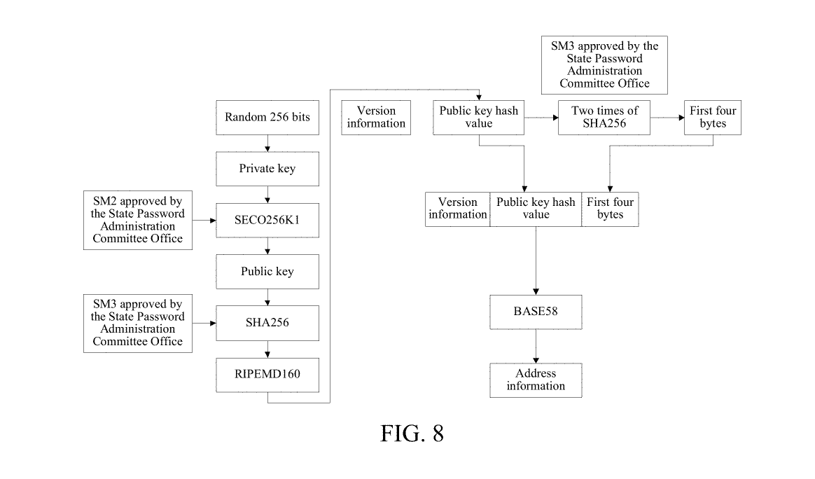

For example, referring to FIG. 8, a process of generating the public key includes: generating, by a user client, a private key based on a random number algorithm (random (256) bits); performing an SECO256K1 operation on the private key, to obtain the public key; performing, by a data sharing system, a hash operation once based on the public key by using SHA256; performing a hash operation again based on an obtained hash value and RIPEMD160, to obtain a public key hash value; performing two hash operations on the public key hash value by using SM3 approved by the State Password Administration Committee Office, to obtain a character string used for verification; obtaining the first four bits of the character string, to serve as a verification code; further, concatenating version information, the public key hash value, and the verification code; and performing a BASE58 algorithm operation on the character string obtained after the concatenation, to obtain address information of the user client.

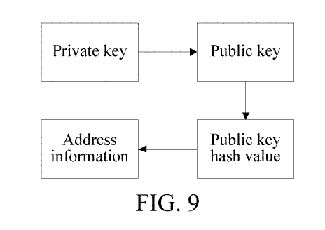

As may be known from FIG. 9, address information is actually generated in the following procedure: a private key-a public key-a public key hash value-address information. In this generation process, a plurality of irreversible operations are performed, a data length of final address information is greatly reduced through the plurality of irreversible operations, which increases the irreversibility of the address information in return, so that the public key cannot be derived based on the address information, that is, the private key of the user client cannot be derived. Because the private key is necessary information for service processing, property security of a user is ensured.

The address information actually represents an account of the user client in the data sharing system. The user client may process a service with another user client or a server by using the address information, for example, transaction behavior such as transferring and subscription. Certainly, to further improve the security, an algorithm plugging design may be used in the foregoing step. An architecture approved by the State Password Administration Committee Office may be used in a necessary scenario. For example, referring to FIG. 8, when a private key is generated, a currently used SEKO256K1 (an elliptic curve cryptography) is replaced with SM2 algorithm approved by the State Password Administration Committee Office. When a hash operation is performed on the public key, a currently used SHA256 algorithm may be replaced with an SM3 algorithm approved by the State Password Administration Committee Office. When a verification code is generated, the currently used SHA256 algorithm may be replaced with the SM3 algorithm approved by the State Password Administration Committee Office.

In step 610, if the address verification information of the user client is consistent with the address information included in the service data, the service processing request is responded; or if the address verification information of the user client is inconsistent with the address information included in the service data, the service processing request is intercepted.

A specific process of responding to the service processing request is not described herein. For details, refer to the processing process on the node side in the embodiment shown in FIG. 2.

To resolve the problem of security and flexibility of an intelligent contract, the service data included in the service processing request in this embodiment may include contract data. The contract data includes an execution condition parameter and an execution parameter of a contract. The execution condition parameter of the contract refers to conditions that are to be met to execute the contract, for example, the contract expires or payment arrives. For a private chain and a union chain, there are different problems. For example, in a private chain completely under control, a function name and a binary code of a parameter are implanted into the service data, to form contract invocation. When an invoking side writes an intelligent contract journal to the chain, other nodes synchronize the binary code. Finally, a consensus is reached based on an execution result, to complete intelligent contract invocation. In a union chain not completely under control, coded script code is implanted into the service data, non-turing-complete script code is executed according to a rule followed by a stack language. An infinite loop is avoided by limiting a script length. If the execution condition parameter is met, service processing indicated by the contract data is performed based on the execution parameter.

For example, if one person purchases an article online, the person may not want to pay immediately, and wants to pay after a vendor makes the delivery. The person may easily create an intelligent contract, and adds related data of the intelligent contract to a service processing request, and sends the service processing request to the data sharing system, so that the data sharing system may add the intelligent contract to a blockchain. Content of the intelligent contract is that the payment for goods is transferred to the vendor provided that data from the Federal Express shows that the commodity has been delivered to a destination. When it is detected that the foregoing condition is met, the service processing of transferring the payment for goods to the vendor may be performed.

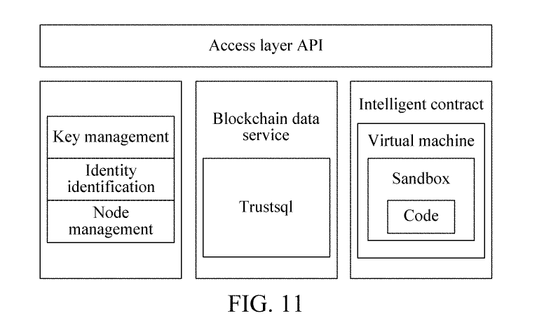

According to the data sharing system provided in this embodiment, the data sharing system may include an access layer adaptation plug-in. The access layer adaptation plug-in actually may be configured to convert a format of the service processing request, so that the data sharing system may be applicable to clients using different database protocols. After being processed by the access layer adaptation plug-in, the service processing request may further be processed by a service logical layer. For example, the service processing request is sent to various nodes for identity verification and other processing. This processing process relates to a storage plug-in and a consensus plug-in, and needs to be performed based on a communication protocol. Bottom-layer storage of the data sharing system may be performed based on a database (DB), a file, and a key-value (KV). The consensus plug-in is mainly configured to verify consistency of data used in nodes in the data sharing system, and may use any consensus algorithm such as Raft, Paxcos, and Pbft. A plurality of communication protocols, such as P2P, TCP, and broadcast are supported in the data sharing system, to implement data exchange in the system. Based on such a layered architecture of the data sharing system, functional architectures of the foregoing three parts may be shown in FIG. 11, including a management service, a data service, and an intelligent contract service. The management service may provide a key-related management service. The management service is classified into key management, identity identification, and node management. The key management may be implemented based on an enhanced key algorithm and the like. The node management is for each node that needs to be added to a union chain or a private chain or exit a union chain or a private chain. The node may be operated in a node management service. When check of a newly added node succeeds, the node will have identity information in the union chain or the private chain, and the identity information is broadcast to other nodes. Each node has its public/private key pair, and may sign broadcast data of the node. After receiving a request, another node verifies the signed data, and intercepts illegal information, to avoid tampering. When a node needs to exit the union chain or the private chain, the key of the node is discarded. Moreover, other nodes are notified of the discarding. The identity identification is mainly performed based on a public key. One public key may represent an identity of one user client, and is used to verify a service processing request, query the verification, and so on. Further, for a data service part, a data service of the data sharing service may be performing related processing on a blockchain based on user data. The intelligent contract service mainly uses an operation environment in which an Ethernet virtual machine (EVM) is an intelligent contract in the Ethernet. Code of the intelligent contract not only is encapsulated by a sandbox, but also is completely isolated during operation. That is, the code is run in a virtual machine. Because code run in the virtual machine cannot access a network, a file system, or another process, the security may be ensured to the largest extent. Moreover, the intelligent contract service may provide more diversified transaction services that are securer for a user, thereby greatly improving flexibility of the data sharing system.

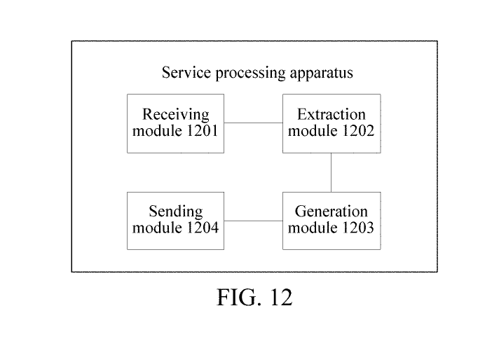

FIG. 12 is a schematic structural diagram of a service processing apparatus according to an embodiment. Referring to FIG. 12, the apparatus includes:

a receiving module 1201, configured to receive a service processing request from a user client, the service processing request being generated according to a table structure provided by a data sharing system, and the service processing request including service data of a user and signature information of the service data of the user;

an extraction module 1202, configured to extract the service data and the signature information of the user from the service processing request;

a generation module 1203, configured to generate a service data recording request of the data sharing system, the service data recording request including the service data and the signature information of the user; and

a sending module 1204, configured to send the service data recording request to at least one node in the data sharing system, so that the at least one node obtains the service data and the signature information from the service data recording request, and stores the service data and the signature information.

In an embodiment, the extraction module 1202 is configured to: identify a database type for generating the service processing request; determine, from a correspondence between a database type and a table structure according to the database type, the table structure used to generate the service processing request; and extract the service data and the signature information of the user from a corresponding field of the service processing request based on the table structure used to generate the service processing request.

In an embodiment, the user client obtains service data entered by the user based on the table structure.

The user client obtains a private key of the user from the user client, and signs the service data by using the private key, to obtain the signature information of the user; and encapsulates the service data and the signature information of the user into the service processing request.

In an embodiment, a node of the data sharing system includes:

an eigenvalue generation module, configured to generate an eigenvalue of a current block according to the service data and the signature information of the user when receiving the service data recording request; and

a block generation module, configured to generate the current block based on the service data and the signature information of the user, an eigenvalue of a previous block, and the eigenvalue of the current block in a blockchain.

In an embodiment, the block generation module includes:

a division submodule, configured to divide the service data and the signature information of the user into at least two parts of data;

a calculation submodule, configured to respectively calculate the at least two parts of data by using different hash algorithms, to obtain hash values of the at least two parts of data; and

a concatenation submodule, configured to concatenate the hash values of the at least two parts of data, to obtain the eigenvalue of the current block.

In an embodiment, the division submodule is configured to determine a division quantity according to data amounts of the service data and the signature information of the user; and divide the service data and the signature information of the user into the determined division quantity of data.

In an embodiment, the block generation module is configured to: sign the service data and the signature information of the user, the eigenvalue of the previous block, and the eigenvalue of the current block in the blockchain by using a private key of a node, to obtain signature information of the current block; correspondingly store the service data and the signature information of the user, the eigenvalue of the previous block, the eigenvalue of the current block in the blockchain, and the signature information of the current block, and generate the current block.

In an embodiment, the service data includes contract data, and the contract data includes an execution condition parameter and an execution parameter of the contract.

In an embodiment, the contract data is a binary code including a function name and a parameter, or the contract data is script code.

In an embodiment, the node further includes a contract execution module, configured to: if the execution condition parameter is met, perform, based on the execution parameter, the service processing indicated by the contract data.

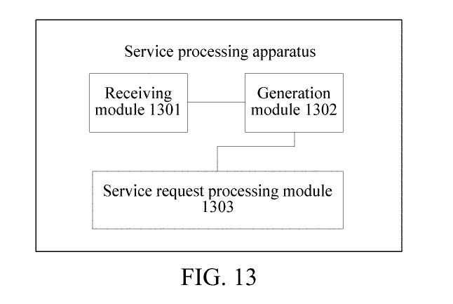

FIG. 13 is a schematic structural diagram of a service processing apparatus according to an embodiment. Referring to FIG. 13, the apparatus includes:

a receiving module 1301, configured to receive a service processing request of a user client, the service processing request including service data and a public key of the user client, and the service data including address information of the user client;

a generation module 1302, configured to: generate address verification information of the user client according to the public key of the user client; and

a service request processing module 1303, configured to: if the address verification information of the user client is consistent with the address information included in the service data, respond to the service processing request; or if the address verification information of the user client is inconsistent with the address information included in the service data, intercept the service processing request.

In an embodiment, the generation module 1302 includes:

a public key hash value obtaining submodule, configured to obtain a public key hash value of the user client;

a hash value obtaining submodule, configured to perform at least two hash operations on the public key hash value, to obtain a hash value of the public key hash value;

a verification code obtaining submodule, configured to: extract, from the hash value of the public key hash value, a byte having a first preset quantity of bits, to serve as a verification code; and

an address information obtaining submodule, configured to: concatenate the public key hash value and the verification code, and code, by using a data format supported by a data sharing system, a character string obtained after the concatenation, to obtain address information of the user client.

In an embodiment, the address information obtaining submodule is configured to concatenate version information of the data sharing system, the public key hash value, and the verification code.

In an embodiment, the service processing request further includes signature information, and the signature information is obtained after the user client signs the service data by using a private key of the user client.

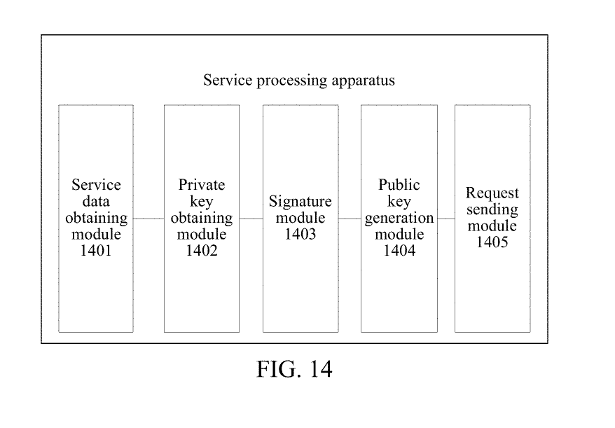

FIG. 14 is a schematic structural diagram of a service processing apparatus according to an embodiment. Referring to FIG. 14, the apparatus includes:

a service data obtaining module 1401, configured to obtain service data;

a private key obtaining module 1402, configured to obtain a private key of a user client;

a signature module 1403, configured to sign the service data by using the private key of the user client, to obtain signature information of the user client;

a public key generation module 1404, configured to generate a public key of the user client according to the private key of the user client; and

a request sending module 1405, configured to: encapsulate the service data and the signature information of the user client, and the public key of the user client into a service processing request, and send the service processing request to the data sharing system.

In an embodiment, the private key obtaining module includes:

a random number generation submodule, configured to generate, by using an asymmetric encryption algorithm, a random number having a first specified quantity of bits; and

an extension submodule, configured to extend a quantity of bits of the random number having the first specified quantity of bits, to obtain a random number having a second specified quantity of bits.

In an embodiment, the extension submodule is configured to concatenate two random numbers having the first specified quantity of bits, to obtain the random number having the second specified quantity of bits.

In an embodiment, the extension submodule is configured to connect a tail of one random number having the first specified quantity of bits to a head of another random number having the first specified quantity of bits, to obtain the random number having the second specified quantity of bits; or

mix, in an insertion manner, a character having a preset quantity of bits in one random number having the first specified quantity of bits with a character having the preset quantity of bits in another random number having the first specified quantity of bits, to obtain the random number having the second specified quantity of bits; or

disrupt characters of one random number having the first specified quantity of bits and another random number having the first specified quantity of bits, to obtain the random number having the second specified quantity of bits.

It should be noted that, when the service processing apparatus provided in the foregoing embodiment processes a service, only an example of division of the foregoing functional modules is described, and in actual application, the foregoing functions may be implemented by different functional modules, that is, the internal structure of the device is divided into different functional modules, to implement all or some of the functions described above. In addition, the service processing apparatus provided in the foregoing embodiment belongs to the same concept as the embodiment of the service processing method. For a specific implementation process of the service processing apparatus, refer to the method embodiment, and details are not described herein again.

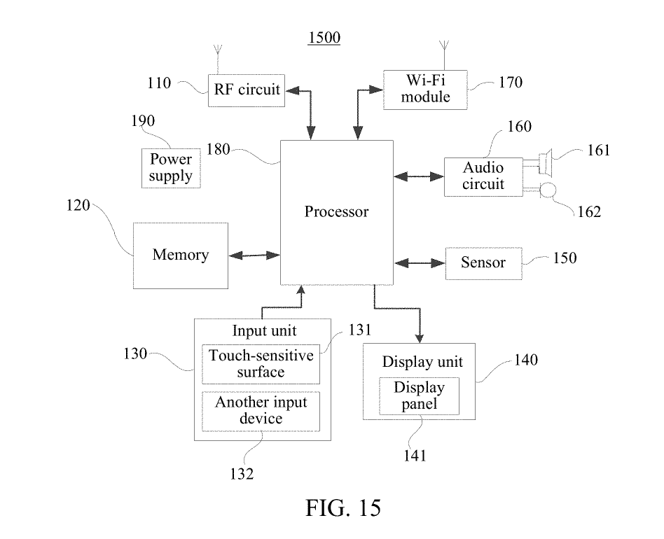

An embodiment provides a terminal. A user client in the foregoing method is run on the terminal, and the terminal is configured to perform the service processing method provided in the foregoing embodiments. Referring to FIG. 15, the terminal 1500 includes:

components such as a radio frequency (RF) circuit 110, a memory 120 including one or more computer readable storage mediums, an input unit 130, a display unit 140, a sensor 150, an audio circuit 160, a wireless fidelity (Wi-Fi) module 170, a processor 180 including one or more processing cores, and a power supply 190. A person skilled in the art may understand that the structure of the terminal shown in FIG. 15 does not constitute any limitation to the terminal, and the terminal may include more or fewer components than those shown in the figure, or some components may be combined, or a different component deployment may be used.

The RF circuit 110 may be configured to receive and send signals during an information receiving and sending process or a call process. Particularly, the RF circuit receives downlink information from a base station, then delivers the downlink information to one or more processors 180 for processing, and sends related uplink data to the base station. Generally, the RF circuit 110 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 110 may also communicate with a network and another device by wireless communication. The wireless communication may use any communication standard or protocol, including but not limited to Global System for Mobile communications (GSM), general packet radio service (GPRS), Code Division Multiple Access (CDMA), Wideband Code Division Multiple Access (WCDMA), Long Term Evolution (LTE), email, Short Messaging Service (SMS), and the like.

The memory 120 may be configured to store a software program and module. The processor 180 runs the software program and module stored in the memory 120, to implement various functional applications and data processing. The memory 120 may mainly include a program storage area and a data storage area. The program storage area may store an operating system, an application program used by at least one function (such as a sound playback function and an image display function), and the like. The data storage area may store data (such as audio data and an address book) created according to use of the terminal 1500, and the like. In addition, the memory 120 may include a high speed random access memory, and may further include a non-volatile memory, such as at least one magnetic disk storage device, a flash memory, or another volatile solid-state storage device. Correspondingly, the memory 120 may further include a memory controller, to provide access of the processor 180 and the input unit 130 to the memory 120.

The input unit 130 may be configured to receive input digit or character information, and generate a keyboard, mouse, joystick, optical, or track ball signal input related to the user setting and function control. Specifically, the input unit 130 may include a touch-sensitive surface 131 and another input device 132. The touch-sensitive surface 131, which may also be referred to as a touchscreen or a touch panel, may collect a touch operation of a user on or near the touch-sensitive surface (such as an operation of a user on or near the touch-sensitive surface 131 by using any suitable object or accessory, such as a finger or a stylus), and drive a corresponding connection apparatus according to a preset program. Optionally, the touch-sensitive surface 131 may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, and sends the touch point coordinates to the processor 180. Moreover, the touch controller may receive and execute a command sent from the processor 180. In addition, the touch-sensitive surface 131 may be a resistive, capacitive, infrared, or surface sound wave type touch-sensitive surface 131. In addition to the touch-sensitive surface 131, the input unit 130 may further include the another input device 132. Specifically, the another input device 132 may include, but is not limited to: one or more of a physical keyboard, a functional key (such as a volume control key or a switch key), a track ball, a mouse, and a joystick.

The display unit 140 may be configured to display information input by the user or information provided for the user, and various graphical user interfaces of the terminal 1500. These graphical user interfaces may include a graph, text, an icon, a video and any combination thereof. The display unit 140 may include a display panel 141. Optionally, the display panel 141 may be configured by using a liquid crystal display (LCD), an organic light-emitting diode (OLED), or the like. Further, the touch-sensitive surface 131 may cover the display panel 141. After detecting a touch operation on or near the touch-sensitive surface 131, the touch-sensitive surface 131 transfers the touch operation to the processor 180, so as to determine a type of the touch event. Then, the processor 180 provides a corresponding visual output on the display panel 141 according to the type of the touch event. Although, in FIG. 15, the touch-sensitive surface 131 and the display panel 141 are used as two separate parts to implement input and output functions, but in some embodiments, the touch-sensitive surface 131 and the display panel 141 may be integrated to implement the input and output functions.

The terminal 1500 may further include at least one sensor 150 such as an optical sensor, a motion sensor, and other sensors. Specifically, the optical sensor may include an ambient light sensor and a proximity sensor. The ambient light sensor may adjust luminance of the display panel 141 according to brightness of the ambient light. The proximity sensor may switch off the display panel 141 and/or backlight when the terminal 1500 is moved to the ear. As one type of motion sensor, a gravity acceleration sensor may detect magnitude of accelerations in various directions (generally on three axes), may detect magnitude and a direction of the gravity when static, and may be applied to an application that recognizes the attitude of the mobile phone (for example, switching between landscape orientation and portrait orientation, a related game, and magnetometer attitude calibration), a function related to vibration recognition (such as a pedometer and a knock), and the like. Other sensors, such as a gyroscope, a barometer, a hygrometer, a thermometer, and an infrared sensor, which may be configured in the terminal 1500, are not further described herein.

The audio circuit 160, a speaker 161, and a microphone 162 may provide audio interfaces between the user and the terminal 1500. The audio circuit 160 may convert received audio data into an electric signal and transmit the electric signal to the speaker 161. The speaker 161 converts the electric signal into a sound signal for output. On the other hand, the microphone 162 converts a collected sound signal into an electric signal. The audio circuit 160 receives the electric signal and converts the electric signal into audio data, and outputs the audio data to the processor 180 for processing. Then, the processor 180 sends the audio data to, for example, another terminal by using the RF circuit 110, or outputs the audio data to the memory 120 for further processing. The audio circuit 160 may further include an earplug jack, to provide communication between a peripheral earphone and the terminal 1500.

Wi-Fi belongs to a short-distance wireless transmission technology. The terminal 1500 may help a user receive or send an email, browse a web page, access a streaming media, and so on by using a Wi-Fi module 170. The terminal 1500 provides wireless broadband Internet access for the user. Although FIG. 15 shows the Wi-Fi module 170, it may be understood that the Wi-Fi module 170 is not a necessary component of the terminal 1500, and the Wi-Fi module 170 may be omitted provided that the scope of the essence of the present disclosure is not changed.

The processor 180 is the control center of the terminal 1500, and is connected to various parts of the mobile phone by using various interfaces and lines. By running or executing the software program and/or module stored in the memory 120, and invoking data stored in the memory 120, the processor 180 performs various functions and data processing of the terminal 1500, thereby performing overall monitoring on the mobile phone. Optionally, the processor 180 may include one or more processing cores. Preferably, the processor 180 may integrate an application processor and a modem processor. The application processor mainly processes an operating system, a user interface, an application program, and the like. The modem processor mainly processes wireless communication. It may be understood that the foregoing modem processor may alternatively not be integrated into the processor 180.

The terminal 1500 further includes the power supply 190 (such as a battery) for supplying power to the components. Preferably, the power supply may be logically connected to the processor 180 by using a power management system, thereby implementing functions such as charging, discharging, and power consumption management by using the power management system. The power supply 190 may further include one or more of a direct current power supply or an alternating current power supply, a re-charging system, a power failure detection circuit, a power supply converter or inverter, a power supply state indicator, and any other component.

Although not shown in the figure, the terminal 1500 may further include a camera, a Bluetooth module, and the like, which are not further described herein. Specifically, in this embodiment, the display unit of the terminal is a touchscreen display, and the terminal further includes a memory and one or more programs, where the one or more programs are stored in the memory, and are configured to be executed by one or more processors. The one or more programs include instructions used to perform operations of the user client in the service processing method.

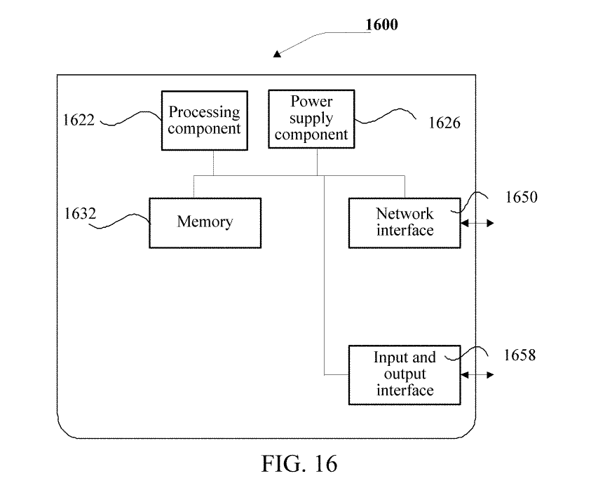

FIG. 16 is a block diagram of a service processing apparatus 1600 according to an exemplary embodiment. For example, the apparatus 1600 may be a data sharing system gateway or a node in a data sharing system. Referring to FIG. 16, the apparatus 1600 includes a processing component 1622, and further includes one or more processors, and memory resources represented by a memory 1632, configured to store instructions that may be executed by the processing component 1622, for example, an application program and machine-readable instructions. The application program stored in the memory 1632 may include one or more modules, where each module corresponds to a group of instructions. In addition, the processing component 1622 is configured to execute instructions, to perform the foregoing service processing method, for example, the methods shown in FIG. 2 and FIG. 6, and to perform functions performed by the apparatus shown in FIG. 12.

The apparatus 1600 further includes: a power supply component 1626, configured to manage power supply of the apparatus 1600; a wired or wireless network interface 1650, configured to connect the apparatus 1600 to a network; and an input/output (I/O) interface 1658. The apparatus 1600 may operate an operating system stored in the memory 1632, for example, Windows Server™, Mac OS X™, Unix™, Linux™, or FreeBSD™.

An exemplary embodiment further provides a non-transitory computer-readable storage medium including instructions, for example, a memory including instructions. The foregoing instructions may be executed by a processor in the terminal, to implement a resource provisioning method or a resource reclaiming method in the following embodiment. For example, the non-transitory computer-readable storage medium may be a ROM, a random access memory (RAM), a CD-ROM, a magnetic tape, a floppy disk, an optical data storage device, or the like.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory, a magnetic disk, an optical disc, or the like.

The foregoing descriptions are merely several embodiments, but are not intended to limit the present disclosure. Any modification, equivalent replacement, or improvement made within the spirit and principle of the present disclosure shall fall within the protection scope of the present disclosure.

What is claimed is:

1. A method comprising:
receiving, by at least one processor, a service processing request from a user client, the service processing request being generated according to a table structure provided by a data sharing system, and including service data and signature information of the service data;
extracting, by at least one processor, the service data and the signature information from the service processing request according to the table structure that is prestored;
generating, by at least one processor, a service data recording request of the data sharing system, the service data recording request including the service data and the signature information; and
sending, by at least one processor, the service data recording request to at least one node in the data sharing system for obtaining and storing the service data and the signature information at the at least one node.

2. The method according to claim 1, further comprising:
identifying a database type for generating the service processing request; and
determining, from a prestored correspondence between a database type and a table structure according to the database type, the table structure used to generate the service processing request,
wherein the service data and the signature information is extracted from a corresponding field of the service processing request based on a field included in the table structure.

3. The method according to claim 1, further comprising:
obtaining a public key of the user client from the service processing request, the service data further comprising address information of the user client;
generating address verification information of the user client according to the public key of the user client; and
performing, in response to the address verification information of the user client being consistent with the address information of the user client, the operation of extracting the service data and the signature information from the service processing request according to the table structure that is prestored.

4. The method according to claim 3, further comprising:
obtaining a public key hash value of the user client;
performing at least two hash operations on the public key hash value, to obtain a hash value of the public key hash value;
extracting, from the hash value of the public key hash value, a byte having a first preset quantity of bits, to serve as a verification code; and
concatenating the public key hash value and the verification code, and code, by using a preset data format, a character string obtained after the concatenation, to obtain the address verification information of the user client.

5. The method according to claim 4, further comprising:
concatenating version information of the data sharing system, the public key hash value, and the verification code.

6. The method according to claim 1, wherein user client is a client of a user that has registered with the data sharing system in advance.

7. The method according to claim 1, wherein the table structure includes a name and a field of a table for storing data in a database, and a field serving as a primary key.

8. A system comprising:
a plurality of intra-system nodes; and
a data sharing system gateway,
wherein the data sharing system gateway is configured to:
receive a service processing request from a user client, the service processing request being generated according to a table structure provided by the data sharing system, and including service data and signature information of the service data;
extract the service data and the signature information from the service processing request according to the table structure that is prestored;
generate a service data recording request of the data sharing system, the service data recording request including the service data and the signature information; and
send the service data recording request to at least one node in the data sharing system; and
wherein any node of the plurality of intra-nodes is configured to:
obtain the service data and the signature information from the service data recording request, and
store the service data and the signature information.

9. The system according to claim 8, wherein any node of the plurality of intra-nodes is further configured to:
divide the service data and the signature information into at least two parts of data in response to receiving the service data recording request;
respectively calculate the at least two parts of data by using different hash algorithms, to obtain hash values of the at least two parts of data;
concatenate the hash values of the at least two parts of data, to obtain an eigenvalue of a current block; and
generate the current block based on the service data, the signature information, an eigenvalue of a previous block, and the eigenvalue of the current block in a blockchain.

10. The system according to claim 9, wherein any node of the plurality of nodes is further configured to:
sign the service data, the signature information, the eigenvalue of the previous block, and the eigenvalue of the current block in the blockchain by using a private key that is prestored, to obtain signature information of the current block; and
correspondingly store the service data, the signature information, the eigenvalue of the previous block, the eigenvalue of the current block in the blockchain, and the signature information of the current block, and generate the current block.

11. The system according to claim 8, wherein data sharing system gateway is configured to:
identify a database type for generating the service processing request; and
determine, from a prestored correspondence between a database type and a table structure according to the database type, the table structure used to generate the service processing request;
wherein the service data and the signature information is extracted from a corresponding field of the service processing request based on a field included in the table structure.

12. The system according to claim 8, wherein data sharing system gateway is configured to:
obtain a public key of the user client from the service processing request, the service data further comprising address information of the user client;
generate address verification information of the user client according to the public key of the user client; and
perform, in response to the address verification information of the user client being consistent with the address information of the user client, the operation of extracting the service data and the signature information from the service processing request according to the table structure that is prestored.

13. The system according to claim 12, wherein data sharing system gateway is configured to:
obtain a public key hash value of the user client;
perform at least two hash operations on the public key hash value, to obtain a hash value of the public key hash value;
extract, from the hash value of the public key hash value, a byte having a first preset quantity of bits, to serve as a verification code; and
concatenate the public key hash value and the verification code, and code, by using a preset data format, a character string obtained after the concatenation, to obtain the address verification information of the user client.

14. The system according to claim 13, wherein data sharing system gateway is configured to:
concatenate version information of the data sharing system, the public key hash value, and the verification code.

15. A non-transitory computer readable storage medium storing computer program code which, when executed by at least one processor, causes the at least one processor to:
receive a service processing request from a user client, the service processing request being generated according to a table structure provided by a data sharing system, and including service data and signature information of the service data;
extract the service data and the signature information from the service processing request according to the table structure that is prestored;
generate a service data recording request of the data sharing system, the service data recording request including the service data and the signature information; and
send the service data recording request to at least one node in the data sharing system for obtaining and storing the service data and the signature information at the at least one node.

16. The computer readable medium according to claim 15, wherein the computer program code, when executed by the at least one processor further causes the processor to:
identify a database type for generating the service processing request; and
determine, from a prestored correspondence between a database type and a table structure according to the database type, the table structure used to generate the service processing request;
wherein the service data and the signature information is extracted from a corresponding field of the service processing request based on a field included in the table structure.

17. The computer readable medium according to claim 15, wherein the computer program code, when executed by the at least one processor further causes the processor to:
obtain a public key of the user client from the service processing request, the service data further comprising address information of the user client;
generate address verification information of the user client according to the public key of the user client; and
perform, in response to the address verification information of the user client being consistent with the address information of the user client, the operation of extracting the service data and the signature information from the service processing request according to the table structure that is prestored.

18. The computer readable medium according to claim 17, wherein the computer program code, when executed by the at least one processor further causes the processor to:
obtain a public key hash value of the user client;
perform at least two hash operations on the public key hash value, to obtain a hash value of the public key hash value;
extract, from the hash value of the public key hash value, a byte having a first preset quantity of bits, to serve as a verification code; and
concatenate the public key hash value and the verification code, and code, by using a preset data format, a character string obtained after the concatenation, to obtain the address verification information of the user client.

19. The computer readable medium according to claim 18, wherein the computer program code, when executed by the at least one processor further causes the processor to:
concatenate version information of the data sharing system, the public key hash value, and the verification code.

20. The computer readable medium according to claim 15, wherein user client is a client of a user that has registered with the data sharing system in advance, and wherein the table structure includes a name and a field of a table for storing data in a database, and a field serving as a primary key.
